(19) United States
(12) Patent Application Publication
(10) Pub. No.: US 2002/0085703 A1
(43) Pub. Date: Jul. 4, 2002

(54) Facility and method for cellular data communication between hearing impaired users and emergency service centers

(76) Inventor: Rod L. Proctor, Seattle, WA (US)

Correspondence Address: Stoel Rives LLP, 900 SW Fifth Avenue, Suite 2600, Portland, OR, 97204-1268, US

(21) Appl. No.: 09/753,638

(22) Filed: Jan. 2, 2001

(51) Int. Cl. H04M 3/00; H04M 11/04

(52) U.S. Cl. 379/265.02; 379/37; 379/52; 455/404

(57) ABSTRACT

A telecommunications system including a digital cellular network, and a call center having a central converter connected to the network, and operable to convert an incoming signal from a first format to a second format. The call center has a TTY/TDD device operable to read the signal in the second format and to output a text version of the signal. A user communication system is connected to the network and includes a user TTY/TDD device operable to convert text to a signal in the second format. A user converter is connected to the user terminal and is operable to convert the signal from the second format to the first format. A cellular device is connected to the user converter and the network, and is operable to communicate the signal in the first format to the network.

### FIELD OF THE INVENTION

The present invention is directed to wireless communication, and more particularly to communications via TTY/TDD systems for the hearing impaired and emergency “9-1-1” call centers.

### BACKGROUND AND SUMMARY OF THE INVENTION

Hearing impaired people use TTY/TDD devices to communicate over telephone networks. Such a device is required on each end of the communication, so that the hearing impaired user may transmit and receive in text format. TTY/TDD devices are essentially modems that modulate a digital signal representing entered text into audible tones that are carried by conventional phone lines, and demodulate the tones to re-create the digital signal at the other end. The digital signals are created by the “speaker” typing text into a TTY/TDD device, and by the “listener” reading the text on a display screen on a comparable device. Each device is capable of both sending and receiving, so that two way communication is enabled.

These communications can be personal, such as to friends and family having such devices, or commercial, such as to companies or entities that provide special lines to communicate with hearing impaired customers and public. These entities include emergency call centers such as municipal 9-1-1 centers, which permit operators to receive and respond emergency calls by callers who would otherwise be unable to communicate readily by voice.

The advent of cellular telephones has enabled most users to make emergency calls when they are away from wired telephones, a significant boon to public safety. However, hearing impaired people do not enjoy these benefits because most cellular telephones and networks are incapable of transmitting the modulated signals generated by the TTY/TDD devices.

The technical reason that the TTY/TDD device cannot communicate over digital cellular networks is the “vocoders” in the cellular voice transmission path. These vocoders compress the voice signals, making more conversations possible in the same bandwidth, thereby conserving spectrum. While effective for transmitting spoken words, the compression responds to modem tones in a way that corrupts the data carried therein, and renders the result unusable. The modem used to send TTY/TDD data over the wireline network is not able to send data through the cellular voice path. Some digital cellular networks have data paths separate from the voice path that could be used to send data to a selected receiving location. However, even in these cases, the TTY/TDD device is not able to connect to the mobile data ports of these phones and the TTY/TDD device at the receiving is not able to connect to standard TTY/TDD devices.

The present invention overcomes the limitations of the prior art by providing a telecommunications system including a digital cellular network, and a call center having a central converter connected to the network, and operable to convert an incoming signal from a first format to a second format. The call center has a TTY/TDD device operable to read the signal in the second format and to output a text version of the signal. A user communication system is connected to the network and includes a user TTY/TDD device operable to convert text to a signal in the second format. A user converter is connected to the user terminal and is operable to convert the signal from the second format to the first format. A cellular device is connected to the user converter and the network, and is operable to communicate the signal in the first format to the network.

### BRIEF DESCRIPTION OF THE DRAWINGS

FIG. 1 is a high-level block diagram showing the environment in which the facility preferably operates.

### DETAILED DESCRIPTION OF A PREFERRED EMBODIMENT

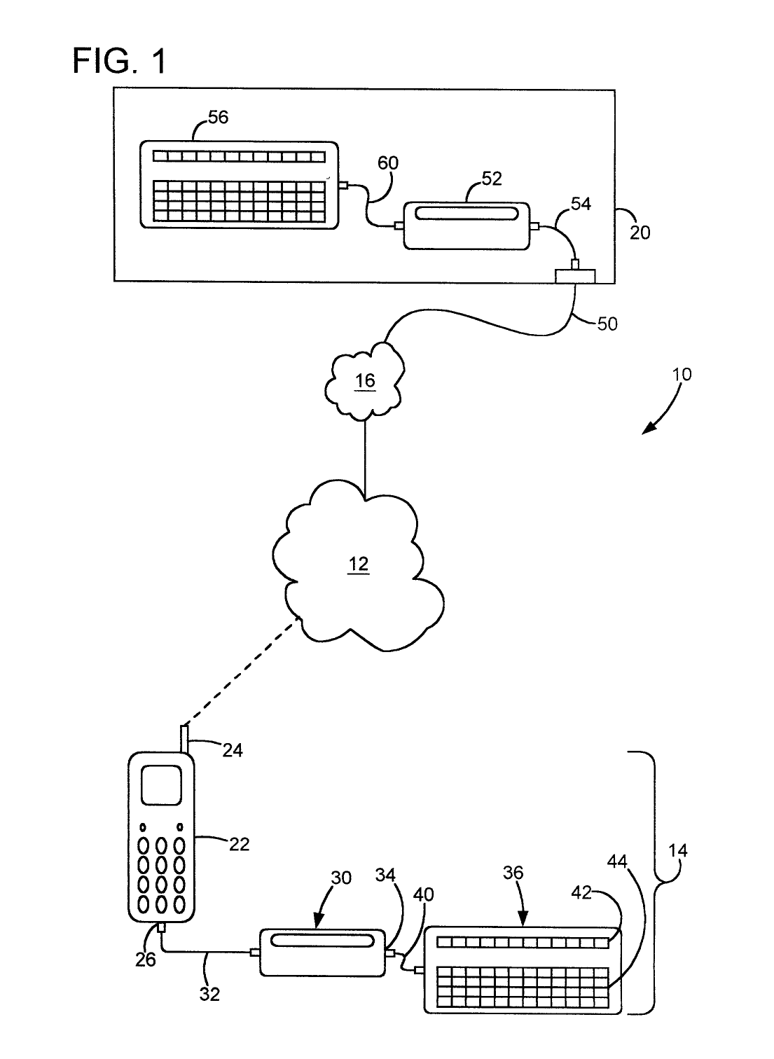

FIG. 1 shows an emergency communication system 10 including a wireless or cellular network 12 with a user system connected to the network. The cellular network is connected to a conventional telephone system 16. A central emergency communication facility 20 such as a public service access point is connected to the system 16. The facility 20 is typically a municipal facility accessed by callers dialing 9-1-1, and is staffed by dispatchers that communicate with callers regarding emergencies, and dispatch emergency services.

The user system includes a digital cellular telephone 22 having an antenna 24 communicating with the cellular network 12. The phone includes circuitry that encodes vocal communications digitally, in a highly compressed format that allows a conversation to be transmitted with limited bandwidth. The circuitry also includes receiving capabilities that receive such a digital stream, and convert it into an audible facsimile of the original words spoken by a caller with who the user is speaking. The phone 22 includes conventional ear piece and microphone, as well as a supplementary connector 26 of the type used for communication with accessories such as hands-free headsets. The connector has several lines, some of which are a remote analog microphone input and an analog speaker output.

A converter 30 is connected to the phone connector via a cable 32. The converter is described in U.S. Pat. No. 6,144,336, by Dan Preston, et al., entitled SYSTEM AND METHOD TO COMMUNICATE TIME STAMPED, 3-AXIS GEO-POSITION DATA WITHIN TELECOMMUNICATION NETWORKS, issued Nov. 7, 2000, and which is incorporated herein by reference. The converter includes a connector 34, to which a conventional TTY/TDD device 36 is connected via a cable 40. The TTY/TDD device 36 includes an alphanumeric display 42 for displaying text to a user based on encoded signals received via cable 40. The TTY/TDD device 36 includes a keyboard or other input device 44 for the user to enter text to be encoded and transmitted via the cable to the converter. The TTY/TDD device 36 operates conventionally, and includes what is essentially a modem that converts the entered text to be sent from digital form to a modulated tonal pattern transmissible via conventional telephone lines; it further operates to receive such a modulated audio signal and convert it to digital form for display.

The central emergency communication facility 20 is connected to the telephone network via phone lines 50. A converter 52 that is essentially functionally identical to converter 30 is connected via line 54 to line 50. A TTY/TDD device 56 is connected via line 60 to the converter 52. The TTY/TDD device 56 need not be a conventional hand held unit as illustrated for simplicity. In alternative embodiments, the device may be in the form of a computer terminal or any device with a user input and display. The input may be in the form of a keyboard, or may use any cursor control device, or audio input with voice recognition software to convert speech to digital text. The display may be substituted with any other text generation and communication device such as a speech synthesizer.

The device 56 may also be embodied in the software and hardware of a computer system used by emergency dispatchers for conventionally received emergency calls, with the hardware being a modem connected to the converter 52, and having a connection to the computer system or terminal processor for generation of text in the desired manner. In addition, the converter need not be a separately housed device, but may be included as an internal circuit board in existing systems, or integrated into the circuitry and or software of systems. As with the user system 14, the facility system 20 operates both for transmission and receiving of messages in text format.

The system in the facility 20 is shown in a simplified form to illustrate the preferred embodiment. As shown, it is connected to a telephone line that may have a special phone number for use by TTY/TDD users. However, in the preferred embodiment, a hearing impaired user would preferably call 9-1-1 or another standard number. Routing hardware and or software would analyze the characteristics of each received call from all callers to identify whether the call was a conventional voice call, or whether it was in the special encoded format generated by a converter 30. Based on this determination, the router directs conventional calls to the conventional systems of the dispatchers, and directs encoded calls to the converter 52, where the text output is readily displayed for the dispatcher.

In the event the need arises, the system operates as follows: A hearing impaired user having a system 14 realizes the need to contact the emergency facility 20. If the user system's components are not set up, the user connects the components as shown (normally, the system should be connected, as the user presumably makes all cellular communications via the TTY/TDD device.) The phone 22 is activated, and the emergency number (e.g. 9-1-1) is dialed by the user. In an alternative embodiment, the TTY/TDD device 36 may control the phone 22, and dialing and other phone functions may be conducted by using the device keyboard 44. In any case, the device 36 is used to generate a communication for the center to receive. The communication may be a standardized emergency message identifying the user, possibly including other information generally helpful in such circumstances as medical alert information. Messages may be selected from a menu of standardized emergency communications, or the user may type in specific information, particularly important information such as address or location. Systems having locating capabilities would automatically transmit this information.

The text message generated in the device 36 is modulated to an audible stream of tones, which are transmitted to the converter 30. The converter converts this signal into a data stream in encoded format that is readily transmitted via digital cellular networks, as described in the incorporated reference. The phone then transmits this encoded stream to a receiver node on the network 12, which transmits the stream via the conventional telephone network to the facility 20.

The facility identifies the stream as an encoded stream in the transmissible format, and if necessary, routes the call to the converter 52. The converter 52 converts the encoded stream into the modulated audible tone signal, which is demodulated by the TTY/TDD device 56, and converted to text for display to the dispatcher. Upon reading the user's transmitted message, the dispatcher may dispatch emergency personnel, and/or may generate a communication to the user confirming receipt of the communication, or requesting further information. This return communication follows the same path as the original communication, being modulated by the device 56, converted to the transmissible format by the converter 52, and transmitted via networks 16 and 12 to be received by the user's phone 22. The encoded stream is converted to a modulated pattern of tones by converter 30, which tones are demodulated into digital form by TTY/TDD device 36 for display to the user. A conversation between the user and dispatcher may continue in this manner.

In an alternative embodiment, the device 30 may have a microphone whose output could be monitored when the modem is not transmitting, such as to relay background sounds for evidentiary and other purposes.

While the above is discussed in terms of preferred and alternative embodiments, the invention is not intended to be so limited.

1. A telecommunications system comprising:
a digital cellular network;
a call center having a central converter connected to the network, and operable to convert an incoming signal from a first format to a second format; and
the call center having a central terminal operable to read the signal in the second format and to output a text version of the signal.

2. The system of claim 1 including:
a source for generating digital data;
a tone generation module for encoding the digital data into a series of audio frequency tones; the audio fragment tones being selected so as to avoid frequencies that are characteristic of human voice thereby minimizing interference with simultaneous voice traffic on the channel;
a voice/data signal encoder/decoder (vocoder) for sampling the audio frequency tones and forming digital signals for transmission over the digital wireless telecommunication network; and
a transmission system for transmitting the digital signals over the audio traffic channel of the digital wireless telecommunication network.

3. The system of claim 1 wherein the first format is a digital cellular-transmissible format.

4. The system of claim 1 wherein the second format is a TTY/TDD device-readable signal.

5. The system of claim 1 wherein the central terminal is a TTY/TDD device.

6. The system of claim 1 wherein the central converter is operable to convert an outgoing signal from the second format to the first format.

7. The system of claim 1 wherein the call center is a public service access point.

8. The system of claim 1 including a user communication system including a user terminal operable to convert text to a signal in the second format, a user converter connected to the user terminal and operable to convert the signal to the first format, and a cellular device connected to the user converter and the network, and operable to communicate the signal in the first format to the call center.

9. The system of claim 8 wherein the user converter and the central converter are operably equivalent.

10. The system of claim 8 wherein the user terminal is a TTY/TDD device.

11. A method of communication comprising:
receiving from a digital cellular network a signal in a first format;
identifying that the signal is in the first format;
converting the signal to a second format; and
converting the signal from the second format to a text format.

12. The method of claim 11 including replying to the signal by generating a reply signal in the second format, converting it to the first format, and transmitting it to the network.

13. The method of claim 11 wherein converting the signal from the second format to a text format includes receiving the signal in a TTY/TDD device.

14. The method of claim 11 wherein the second format is a TTY/TDD signal.

15. The method of claim 11 including a user engaging in the steps of:
entering a text message to a terminal,
converting the message to a signal in the second format,
converting the signal in the second format to a signal in the first format, and
transmitting the signal to the network.

16. The method of claim 15 including the user converting a reply signal from the network from the first format to the second format, and from the second format to a text format.

17. The method of claim 11 including:
providing a wireless remote communication apparatus (“RCA”) having a vocoder for transmitting and receiving human voice content over a voice channel of the digital wireless communication network;
providing a call receiver apparatus (“CRA”) also capable of transmitting and receiving human voice content over a voice channel of the digital wireless communication network;
defining one or more control codes reserved for communication control signaling over the voice channel, each control code comprising one or more alpha-numeric characters;
establishing a digital voice channel connection between the RCA and the call receiver apparatus CRA;
in a first one of the RCA and the CRA, selecting one of the communication control codes for transmission to the other one of the RCA and the CRA;
in the first one of the RCA and the CRA, converting the selected control code into an audio tone representation;
in the first one of the RCA and the CRA, formatting the audio tones in a vocoder so as to form digital transmission data;
in the first one of the RCA and the CRA, transmitting the digital transmission data over the digital voice channel connection to the other one of the RCA and the CRA; and
in the other one of the RCA and the CRA, detecting the control code to effect control signaling transparently over the voice channel.

18. A telecommunications system comprising:
a digital cellular network;
a call center having a central converter connected to the network, and operable to convert an incoming signal from a first format to a second format;
call center having a TTY/TDD device operable to read the signal in the second format and to output a text version of the signal;
a user communication system connected to the network including a user TTY/TDD device operable to convert text to a signal in the second format;
a user converter connected to the user terminal and operable to convert the signal from the second format to the first format; and
a cellular device connected to the user converter and the network, and operable to communicate the signal in the first format to the network.

19. The system of claim 18 including:
a source for generating digital data;
a tone generation module for encoding the digital data into a series of audio frequency tones; the audio fragment tones being selected so as to avoid frequencies that are characteristic of human voice thereby minimizing interference with simultaneous voice traffic on the channel;
a voice/data signal encoder/decoder (vocoder) for sampling the audio frequency tones and forming digital signals for transmission over the digital wireless telecommunication network; and
a transmission system for transmitting the digital signals over the audio traffic channel of the digital wireless telecommunication network.
